(19) United States
(12) Patent Application Publication
(10) Pub. No.: US 2015/0291794 A1
(43) Pub. Date: Oct. 15, 2015

(54) COMPOSITION CONTAINING A SEMI-AROMATIC COPOLYAMIDE, A POLYOLEFIN AND A COPPER HEAT STABILIZER, PREPARATION THEREOF AND USES THEREOF

(71) Applicant: ARKEMA FRANCE, Colombes (FR)

(72) Inventors: Philippe Blondel, Bernay (FR); Thierry Briffaud, Caorches Saint Nicolas (FR)

(73) Assignee: ARKEMA FRANCE, Colombes (FR)

(21) Appl. No.: 14/441,647

(22) PCT Filed: Nov. 18, 2013
(86) PCT No.: PCT/EP2013/074082

§ 371 Date: May 8, 2015

(30) Foreign Application Priority Data
Nov. 19, 2012 (FR) 1260965

(51) Int. Cl. C08L 77/06

(52) U.S. Cl. CPC C08L 77/06; C08L 2201/08; C08L 2203/20

(57) ABSTRACT

The invention relates to a composition comprising from 10% to 36% by weight of at least one polyolefin, from 0.05% to 0.30% by weight of at least one copper heat stabilizer, wherein the copper heat stabilizer is a mixture of potassium iodide and copper iodide, and at least one predominant semi-aromatic copolyamide comprising at least two distinct units corresponding to the following general formula: A/X.T in which: A is chosen from at least one unit obtained from an amino acid, at least one unit obtained from a lactam and at least one unit corresponding to the formula (Ca diamine).(Cb diacid), and the mixtures thereof, X.T denotes a unit obtained from the polycondensation of a Cx diamine denoted X and of terephthalic acid denoted T, the weight percentages being given relative to the total weight of the composition.

The present invention relates to a composition including at least one semi-aromatic copolyamide, at least one polyolefin, and at least one copper heat stabilizer, to the method for the preparation thereof, as well as to the uses thereof, in particular in the manufacture of various objects, such as common consumer products, for example, electrical and electronic equipment, or cars, surgical material, packaging material or sports articles. The invention pertains essentially to the use of said composition for the manufacture of tubes for applications under the engine hood.

### PRIOR ART AND TECHNICAL PROBLEM

In the car industry, for example, compositions based on one or more semi-aromatic polyamides are used increasingly because of the remarkable thermomechanical properties that they confer to parts made from such compositions.

Most particularly, in the automotive industry, particularly in the “cooling” sector, there is a demand for materials that are resistant to high temperature, that is to a temperature above 130° C. Indeed, the car manufacturers are building increasingly confined engines in which and around which the temperature of the ambient air is increasingly high.

The temperature of the air surrounding the engine is on the increase for reasons pertaining to yield and noise. This applies particularly to diesel engines with common-rail direct injection. In the case of polyamide-based thermoplastic tubes that convey coolant, the external surface is in contact with hot air and the internal surface is in contact with aggressive liquids. The higher outside temperature will tend to increase the temperature of the liquid, making the latter even more aggressive against the thermoplastic material of the tube. The resistance to aging under exposure to liquids, such as coolant, therefore needs to be improved. Under the action of more elevated temperatures, these liquids are particularly susceptible to oxidation and to degradation. The typical result is the formation of peroxides that decompose into free radicals, which in turn attack the polymer material of the car part in contact with said liquid.

These concerns relate particularly, but in a non-limiting manner, to the structures present in the form of tubes used for the circulation of aggressive liquids, such as coolants, brake fluids, to the parts located in proximity of the engine, or to structures such as tanks.

In order to improve the resistance to thermal aging of such structures, the latter are generally produced from compositions including a polymer, conventionally a polyamide, various additives such as a plasticizer, an impact modifier, and a stabilizer.

It would thus be advantageous to discover a resistant material that has excellent resistance to aging in contact with aggressive fluids.

The document US 2008/0038499 describes a composition including in particular a semi-aromatic copolyamide and a polyolefin for manufacturing water tubes used in cars.

The compositions used today lead to lifespans of approximately 400 h. Consequently, these parts have to be replaced regularly. Multilayer tubes also exist that are formed by a barrier layer against internal fluids, which is generally based on fluorinated polymers, and by a heat resistant layer on the outside. These structures have a much longer lifespan, but the use of fluorinated material is extremely costly and these are materials that are difficult to transform.

Thus, there is a real need to find new compositions that make it possible to produce parts that simultaneously have, on the outside, an improved resistance to high temperature such as, for example, temperatures between 130 and 175° C., and, on the outside, improved resistance to aggressive liquids, particularly at high temperatures such as 80 to 130° C., while keeping a reasonable cost of production.

### BRIEF DESCRIPTION OF THE INVENTION

Surprisingly, the applicant has found that this demand is met by a composition including
from 10 to 36% by weight of at least one polyolefin,
from 0.5 to 0.30% by weight of at least one copper heat stabilizer, the copper heat stabilizer being a mixture of potassium iodide and copper iodide, and
at least one semi-aromatic copolyamide having a predominant structure A/X.T in which:

A is chosen from
at least one unit obtained from an amino acid,
at least one unit obtained from a lactam, and
at least one unit corresponding to the formula (Ca diamine).(Cb diacid), with a representing the number of carbon atoms of the diamine between 6 and 18, and b representing the number of carbon atoms of the diacid between 6 and 32, and their mixtures,

X.T denotes a unit obtained from the polycondensation of a Cx diamine denoted X and from terephthalic acid denoted T, with x representing the number of carbon atoms of the Cx diamine, x being between 9 and 36, and advantageously between 10 and 18, the weight percentages being given relative to the total weight of the composition.

It was observed that dumbbell specimens manufactured from said composition led to an improved aging in an aggressive medium at 130° C.

The invention further relates to a method for preparing the composition, as well as to its uses, in particular as constituent layer of a structure which may be single-layer or multilayer.

The invention further relates to a part formed entirely or partially from a composition according to the invention as well as to the uses of such a part.

Lastly, the invention relates to the use of from 0.05 to 0.50% by weight relative to the total weight of the composition of a copper heat stabilizer within a composition including as predominant constituent at least one polyamide of structure A/X.T as defined above and 10 to 36% by weight of a polyolefin for the manufacture of parts that are resistant to aging, particularly in aggressive hot liquids, in particular in coolants.

### DETAILED DESCRIPTION OF THE INVENTION

Other characteristics, aspects, subject matters and advantages of the present invention will become clearer upon reading the following description and examples.

The nomenclature used for defining the polyamides is described in the standard ISO 1874-1:1992 “Plastiques—Matériaux polyamides (PA) pour moulage et extrusion-Partie 1: Désignation [Plastics-Polyamide (PA) materials for molding and extrusion-Part 1: Designation],” in particular on page 3 (Tables 1 and 2) and is well-known to the person skilled in the art.

Moreover, it is specified that the expressions “between . . . and . . . ” and “from . . . to . . . ” used in the present description must each be understood to include the limit terms mentioned.

### The Semi-Aromatic Copolyamide

The composition according to the invention includes at least one predominant semi-aromatic copolyamide including at least two different units corresponding to the following general formula:

A/X.T

in which:
A is chosen from
   at least one unit obtained from an amino acid,
   at least one unit obtained from a lactam, and
   at least one unit corresponding to the formula (Ca diamine).(Cb diacid), with
a representing the number of carbon atoms of the diamine between 6 and 18, and
b representing the number of carbon atoms of the diacid between 6 and 32, and their mixtures,
X.T denotes a unit obtained from the polycondensation of a Cx diamine denoted X and of terephthalic acid denoted T, with x representing the number of carbon atoms of the Cx diamine, x being between 9 and 36, advantageously between 10 and 18.

Concerning more specifically the meaning of unit A, when A represents an amino acid, it can be chosen from 9-aminononanoic acid (A=9), 10-aminodecanoic acid (A=10), 10-aminoundecanoic acid (A=11), 12-aminododecanoic acid (A=12), and 11-aminoundecanoic acid (A=11) as well as its derivatives, particularly N-heptyl-11-aminoundecanoic acid.

Instead of an amino acid, one could also consider a mixture of two, three, . . . or more amino acids. However, the copolyamides formed would then include three, four, . . . or more units, respectively.

When A represents a lactam, it can be chosen from pyrrolidinone, 2-piperidinone, enantholactam, caprylolactam, pelargolactam, decanolactam, undecanolactam, and lauryllactam (A=12).

Preferably, A denotes a unit obtained from a monomer chosen from 10-aminoundecanoic acid (denoted 11), 11-aminoundecanoic acid (denoted 11), 12-aminododecanoic acid (denoted 12) and lauryllactam (denoted 12).

When the unit A is a unit corresponding to the formula (Ca diamine).(Cb diacid), the (Ca diamine) unit is chosen from the aliphatic, linear or branched, diamines.

When the diamine is aliphatic and linear, of formula H₂N—(CH₂)ₐ—NH₂, the (Ca diamine) monomer is preferably chosen from hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18) and the diamines obtained from fatty acids.

When the diamine is aliphatic and branched, it can include one or more methyl or ethyl substituents on the main chain. For example, the monomer (Ca diamine) can advantageously be chosen from 2,2,4-trimethyl-1,6-hexanediamine, 2,4,4-trimethyl-1,6-hexanediamine, 1,3-diaminopentane, 2-methyl-1,5-pentanediamine, 2-methyl-1,8-octanediamine.

Preferably, the Ca diamine of the A unit has a number of carbon atoms between 7 and 18.

The (Cb diacid) unit is chosen from the aliphatic, linear or branched, diacids and the aromatic diacids.

When the (Cb diacid) monomer is aliphatic and linear, it is chosen from adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18), octadecenedioic acid (b=18), eicosanedioic acid (b=20), docosanedioic acid (b=22) and the dimers of fatty acids containing 36 carbons.

The dimers of fatty acids mentioned above are dimerized fatty acids obtained by oligomerization or polymerization of unsaturated monobasic fatty acids with long hydrocarbon chain (such as linoleic acid and oleic acid), as described, in particular, in the document EP 0 471 566.

When the diacid is aromatic, it is chosen from terephthalic acid (denoted T), isophthalic acid (denoted I), and the naphthalenic diacids.

Advantageously, the unit A denotes 10-aminoundecanoic acid (denoted 11).

The X unit denotes a unit obtained from a diamine having a number of carbons, denoted x, between 9 and 36, preferably between 10 and 18, and more preferably equal to 10.

This diamine can be aliphatic, linear or branched.

When the diamine is aliphatic and branched, it can comprise one or more methyl or ethyl substituents on the main chain. For example, it can advantageously be chosen from 2,2,4-trimethyl-1,6-hexanediamine, 2,4,4-trimethyl-1,6-hexanediamine and 2-methyl-1,8-octanediamine.

Advantageously the diamine is aliphatic and linear, the diamine is of formula H₂N—(CH₂)ₓ—NH₂ and is chosen from nonanediamine (x=9), decanediamine (x=10), undecanediamine (x=11), dodecanediamine (x=12), tridecanediamine (x=13), tetradecanediamine (x=14), hexadecanediamine (x=16), octadecanediamine (x=18), octadecenediamine (x=18), eicosanediamine (x=20), docosanediamine (x=22) and the diamines obtained from fatty acids.

Preferably, the X unit denotes a unit obtained from 1,10-decanediamine (x=10).

Among the combinations that can be considered, the following copolyamides have a particularly pronounced advantage: they are copolyamides corresponding to one of the formulas chosen from 11/10.T, 12/10.T, 6.10/10.T, 6.12/10.T, 10.10/10.T, 10.12/10.T and 12.12/10.T.

Preferably, the copolyamides correspond to one of the formulas chosen from PA11/10.T, PA12/10T, PA10.10/10.T, PA10.12/10.T, PA12.12/10.T.

Preferably, the molar proportions of diamine denoted X and of terephthalic acid denoted T are preferably stoichiometric.

According to a second aspect of the invention, the copolyamide is a copolymer containing only two different units, namely a unit A and the unit X.T, preferably 10.T.

According to a third aspect of the invention, the copolyamide includes at least three different units and corresponds to the following formula:

A/X.T/Z

in which

the units A and X.T have the same meaning as defined above, and

Z is chosen from a unit obtained from an amino acid, a unit obtained from a lactam and a unit corresponding to the formula (Cd diamine).(Ce diacid), with d representing the number of carbon atoms of the diamine and e representing the number of carbon atoms of the diacid, and d and e each being between 4 and 36, advantageously between 9 and 18.

When Z represents a unit obtained from an amino acid, it can be chosen from 9-aminononanoic acid (Z=9), 10-aminodecanoic acid (Z=10), 10-aminoundecanoic acid (denoted 11), 12-aminododecanoic acid (Z=12) and 11-aminoundecanoic acid (Z=11) as well as its derivatives, in particular, N-heptyl-11-aminoundecanoic acid.

Instead of an amino acid, one could also consider using a mixture of two, three, . . . or more amino acids. In this case, the copolyamides formed would then include four, five, . . . or more units, respectively.

When Z represents a unit obtained from a lactam, it can be chosen from pyrrolidinone, 2-piperidinone, caprolactam (Z=6), enantholactam, caprylolactam, pelargolactam, decanolactam, undecanolactam, and lauryllactam (Z=12).

Instead of a lactam, one could also consider using a mixture of two, three, . . . or more lactams or mixture of one or more amino acids and of one or more lactams. In this case, the copolyamides formed would then include four, five, . . . or more units, respectively.

Among the combinations that can be considered, the following copolyamides are of particularly pronounced advantage: they are copolyamides corresponding to one of the formulas chosen from 11/10.T/12, 11/10.T/6 and 12/10.T/6.

Obviously, one excludes the particular case wherein the unit Z, when it is a unit obtained from a lactam or from an amino acid, is strictly identical to the unit A. Indeed, in this particular case, one is in the presence of the copolyamide that has already been considered according to the first aspect of the invention.

When the unit Z is a unit corresponding to the formula (Cd diamine).(Ce diacid), the (Cd diamine) unit is chosen from the aliphatic, linear or branched, diamines, the cycloaliphatic diamines and the alkyl aromatic diamines.

When the diamine is aliphatic and linear, of formula H₂N—(CH₂)_{d}—NH₂, the (Cd diamine) monomer is chosen from butanediamine (d=4), pentanediamine (d=5), hexanediamine (d=6), heptanediamine (d=7), octanediamine (d=8), nonanediamine (d=9), decanediamine (d=10), undecanediamine (d=11), dodecanediamine (d=12), tridecanediamine (d=13), tetradecanediamine (d=14), hexadecanediamine (d=16), octadecanediamine (d=18), octadecenediamine (d=18), eicosanediamine (d=20), docosanediamine (d=22) and the diamines obtained from fatty acids.

When the diamine is aliphatic and branched, it can comprise one or more methyl or ethyl substituents on the main chain. For example, the (Cd diamine) monomer can advantageously be chosen from 2,2,4-trimethyl-1,6-hexanediamine, 2,4,4-trimethyl-1,6-hexanediamine, 1,3-diaminopentane, 2-methyl-1,5-pentanediamine, 2-methyl-1,8-octanediamine.

When the (Cd diamine) monomer is cycloaliphatic, it is chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), p-bis(aminocyclohexyl)methane (PACM) and isopropylidenedi(cyclohexylamine) (PACP). It can also comprise the following carbon skeletons: norbornyl methane, cyclohexylmethane, dicyclohexylpropane, di(methylcyclohexyl), di(methylcyclohexyl)propane. A non-exhaustive list of these cycloaliphatic diamines is given in the publication “Cycloaliphatic Amines” (Encyclopaedia of Chemical Technology, Kirk-Othmer, 4th Edition (1992), pp. 386-405).

When the (Cd diamine) monomer is alkyl aromatic, it is chosen from 1,3-xylylene diamine and 1,4-xylylene diamine.

The (Ce diacid) unit is chosen from the aliphatic, linear or branched, diacids, the cycloaliphatic diacids and the aromatic diacids.

When the (Ce diacid) monomer is aliphatic and linear, it is chosen from succinic acid (e=4), pentanedioic acid (e=5), adipic acid (e=6), heptanedioic acid (e=7), octanedioic acid (e=8), azelaic acid (e=9), sebacic acid (e=10), undecanedioic acid (e=11), dodecanedioic acid (e=12), brassylic acid (e=13), tetradecanedioic acid (e=14), hexadecanedioic acid (e=16), octadecanedioic acid (e=18), octadecenedioic acid (e=18), eicosanedioic acid (e=20), docosanedioic acid (e=22) and the dimers of fatty acids containing 36 carbons.

The above-mentioned dimers of fatty acids are dimerized fatty acids obtained by oligomerization or polymerization of unsaturated monobasic fatty acids with long hydrocarbon chain (such as, linoleic acid and oleic acid), as described, in particular, in the document EP 0 471 566.

When the diacid is cycloaliphatic, it can comprise the following carbon skeletons: norbornyl methane, cyclohexylmethane, dicyclohexylmethane, dicyclohexylpropane, di(methylcyclohexyl), di(methylcyclohexyl)propane.

When the diacid is aromatic, it is chosen from terephthalic acid (denoted T), isophthalic acid (denoted I) and the naphthalenic diacids.

Obviously, one excludes the particular case wherein the unit (Cd diamine).(Ce diacid) is strictly identical to the unit 10.T or to the unit A, when A has the following meaning: (Ca diamine).(Cb diacid). Indeed, in these particular cases, the presence of the polyamide has already been considered according to the second aspect of the invention.

Among all the possible combinations for the copolyamides A/10.T/Z, in which Z is a unit (Cd diamine).(Ce diacid), one should retain, in particular, the copolyamides corresponding to one of the formulas chosen from 11/10.T/10.I, 12/10.T/10.I, 10.10/10.T/10.I, 10.6/10.T/10.I and 10.14/10.T/10.I.

Preferably, when Z denotes a unit (Cd diamine).(Ce diacid), the (Ce diacid) monomer is aliphatic and linear. One should retain, in particular, the copolyamides corresponding to one of the formulas chosen from 11/10.T/10.6 and 12/10.T/10.6.

In an advantageous version of the invention, the molar ratio of the sum of the units A and Z to the unit(s) 10.T (i.e., (A+Z)/10.T) in the terpolymer is between 0.1 and 1, and preferably between 0.2 and 0.7.

Instead of a unit (Cd diamine).(Ce diacid), one could also consider using a mixture of two, three, . . . or more units (Cd diamine).(Ce diacid) or a mixture of one or more amino acids and/or of one or more lactams with one or more units (Cd diamine).(Ce diacid). In this case, the copolyamides formed would then include four, five, . . . or more units, respectively.

The copolyamide according to the invention can include monomers originating from resources from renewable raw materials, that is to say comprising organic carbon originating from biomass and determined according to the standard ASTM D6866. These monomers originating from renewable raw materials can be 1,10-decanediamine or, when they are present, in particular 11-aminoundecanoic acid, the aliphatic and linear diamines and diacids as defined above.

While, with the exception of N-heptyl-11-aminoundecanoic acid, the dimers of fatty acids and the cycloaliphatic diamines, the comonomers or starting products considered in the present description (amino acids, diamines, diacids) are in fact linear, nothing prohibits considering that they can be entirely or partially branched, such as 2-methyl-1,5-diaminopentane, and/or partially unsaturated.

One should note in particular that the C₁₈ carboxylic diacid can be octadecanedioic acid, which is saturated, or, on the other hand, octadecenedioic acid, which has an insaturation.

Predominant copolyamide, in the sense of the present invention, means that the copolyamide is the component whose content is greater than that of the other components of the composition. The copolyamide thus constitutes the matrix of the composition. Preferably, the copolyamide is present in a proportion of more than 40%, preferably more than 50% by weight relative to the total weight of the composition.

Advantageously, the semi-aromatic polyamide has a melting temperature above 230° C., advantageously between 240° C. and 280° C., and more particularly between 250° C. and 270° C.

Preferably, the semi-aromatic copolyamide according to the invention is a copolyamide of structure 11/10.T, and more preferably a copolyamide of structure 11/10.T originating from the polycondensation of amino-11-undecanoic acid, 1,10-decanediamine and terephthalic acid.

According to a preferred embodiment, the molar ratio of unit 11 to unit 10.T is between 0.5/1.1 (meaning 0.5 mole of unit originating from amino-11-undecanoic acid per 1 mole of unit originating from 1,10-decanediamine and 1 mole of unit originating from terephthalic acid) and 1/1.1.

Preferably, the molar ratio between unit 11 and unit 10.T is 0.5/1.1.

According to a first preferred embodiment, the copolyamide according to the invention has a melting temperature of 255-260° C., with a molar ratio of 0.7/1.1.

According to a second preferred embodiment, the copolyamide according to the invention has a melting temperature of 270° C., with a molar ratio of 0.5/1.1.

Preferably, the amine chain end content of the copolyamide that can be used according to the invention is between 0.020 and 0.058 meq/g.

The amine chain end content is measured in a conventional manner known to the person skilled in the art by NMR (Nuclear Magnetic Resonance).

### The Polyolefin

The composition according to the invention includes 10 to 36% by weight relative to the total weight of the composition of at least one polyolefin. The polyolefin according to the invention can be chosen from a cross-linked polyolefin, a functionalized polyolefin, and their mixture, and optionally a nonfunctionalized polyolefin.

### Cross-Linked Polyolefin

The cross-linked polyolefin can be in the form of a phase that is dispersed in the matrix formed by the polyamide(s).

This cross-linked polyolefin originates from the reaction of two or at least two products having mutually reactive groups.

More particularly, the cross-linked polyolefin is obtained from at least one product (A) including an unsaturated epoxy and from at least one product (B) including an unsaturated carboxylic acid anhydride.

Product (A) is advantageously a polymer including an unsaturated epoxy, this epoxy being introduced into said polymer either by grafting or by copolymerization.

The unsaturated epoxy can be chosen, in particular, from the following epoxies:
the aliphatic glycidyl esters and ethers such as allyl glycidyl ether, vinyl glycidyl ether, glycidyl maleate and itaconate, glycidyl acrylate and methacrylate, and
the alicyclic glycidyl esters and ethers such as 2-cyclohexene-1-glycidyl ether, cyclohexene-4,5-diglycidyl carboxylate, cyclohexene-4-glycidyl carboxylate, 5-norbornene-2-methyl-2-glycidyl carboxylate and endo-cis-bicyclo(2,2,1)-5-heptene-2,3-diglycidyl dicarboxylate.

According to a first form, product (A) is a polyolefin grafted with an unsaturated epoxy. Polyolefin denotes a homopolymer or a copolymer including one or more olefin units such as ethylene, propylene, 1-butene units or any other alpha-olefin units. As polyolefin examples, one can mention:
polyethylene and, in particular, low-density polyethylene (LDPE), high-density polyethylene (HDPE), linear low-density polyethylene (LLDPE) and very low-density polyethylene (VLDPE); polypropylene; the ethylene/propylene copolymers; the elastomer polyolefins such as ethylene-propylene (EPR or EPM) or ethylene-propylene-diene monomer (EPDM); or the metallocene polyethylenes obtained by monosite catalysis;
the styrene/ethylene-butene/styrene block copolymers (SEBS); the styrene/butadiene/styrene block copolymers (SBS); the styrene/isoprene/styrene block copolymers (SIS); or the styrene/ethylene-propylene/styrene block copolymers;
the copolymers of ethylene and of at least one product chosen from the salts of unsaturated carboxylic acids, the unsaturated carboxylic acid esters and the saturated carboxylic acid vinyl esters. In particular, the polyolefin can be a copolymer of ethylene and of alkyl(meth)acrylate or a copolymer of ethylene and of vinyl acetate.

According to a second form, product (A) is a copolymer of alpha-olefin and of an unsaturated epoxy and, advantageously, a copolymer of ethylene and of an unsaturated epoxy. Advantageously, the quantity of unsaturated epoxy can represent up to 15% by weight of the copolymer (A), the quantity of ethylene itself representing at least 50% by weight of the copolymer (A).

More particularly, one can mention the copolymers of ethylene, of a saturated carboxylic acid vinyl ester and of an unsaturated epoxy as well as the copolymers of ethylene, of an alkyl(meth)acrylate and of an unsaturated epoxy. Preferably, the alkyl of the (meth)acrylate alkylate has from 2 to 10 carbon atoms. Examples of alkyl acrylates or methacrylates that can be used are, in particular, methyl acrylate, methyl methacrylate, ethyl acrylate, n-butyl acrylate, isobutyl acrylate and 2-ethylhexyl acrylate.

According to an advantageous version of the invention, product (A) is a copolymer of ethylene, of methyl acrylate and of glycidyl methacrylate or a copolymer of ethylene, of n-butyl acrylate and of glycidyl methacrylate. In particular, one can use the product marketed by the company ARKEMA under the name LOTADER® AX8900.

According to another form of the invention, product (A) is a product having two epoxy functions such as, for example, the diglycidyl ether of bisphenol A (DGEBA).

Product (B) is advantageously a polymer including an unsaturated carboxylic acid anhydride, this unsaturated carboxylic acid anhydride being introduced into said polymer either by grafting or by copolymerization.

Examples of unsaturated dicarboxylic acid anhydrides that can be used as constituents of product (B) are, in particular, maleic anhydride, itaconic anhydride, citraconic anhydride and tetrahydrophthalic anhydride.

According to a first form, product (B) is a polyolefin grafted with an unsaturated carboxylic acid anhydride. As seen above, a polyolefin is a homopolymer or copolymer including one or more olefin units such as ethylene, propylene, 1-butene units or any other alpha-olefin unit. This polyolefin can be chosen, in particular, from the examples of polyolefins listed above for product (A), when the latter is a polyolefin grafted with an unsaturated epoxy.

According to a second form, product (B) is a copolymer of alpha-olefin and of an unsaturated carboxylic acid anhydride and, advantageously, a copolymer of ethylene and of an unsaturated carboxylic acid anhydride. Advantageously, the quantity of unsaturated carboxylic acid anhydride can represent up to 15% by weight of the copolymer (B), the quantity of ethylene itself representing at least 50% by weight of the copolymer (B).

More particularly, one can mention the copolymers of ethylene, of a saturated carboxylic acid vinyl ester, and of an unsaturated carboxylic acid anhydride of as well as the copolymers of ethylene, of an alky(meth)acrylate and of an unsaturated carboxylic acid anhydride. Preferably, the alkyl of the (meth)acrylate has from 2 to 10 carbon atoms. The alkyl acrylate or methacrylate can be chosen from those mentioned above for product (A).

According to an advantageous version of the invention, product (B) is a copolymer of ethylene, of an alkyl(meth)acrylate and of an unsaturated carboxylic anhydride. Preferably, product (B) is a copolymer of ethylene, of ethyl acrylate and of maleic anhydride or a copolymer of ethylene, of butyl acrylate and of maleic anhydride. One can also use the products marketed by the company ARKEMA under the names LOTADER® 4700 and LOTADER® 3410.

One would not go beyond the scope of the invention if some of the maleic anhydride of product (B), according to the first and second forms that have just been described, were in part hydrolyzed.

According to a particular embodiment of the invention, the weight contents of product (A) and of product (B), which are denoted [A] and [B], respectively, can be such that the ratio [B]/[A] is between 3 and 14 and, advantageously, between 4 and 9.

In the composition according to the invention, the cross-linked polyolefin can also be obtained from the products (A), (B) as described above and from at least one product (C), this product (C) including an unsaturated carboxylic acid or an alpha-omega-aminocarboxylic acid.

Product (C) is advantageously a polymer including an unsaturated carboxylic acid or an alpha-omega-aminocarboxylic acid, either of these acids being introduced into said polymer by copolymerization.

Examples of unsaturated carboxylic acids that can be used as constituents of product (C) are, in particular, acrylic acid, methacrylic acid, the carboxylic acid anhydrides which were mentioned above as constituents of product (B), these anhydrides being completely hydrolyzed.

Examples of alpha-omega-aminocarboxylic acids that can be used as constituents of product (C) are, in particular, 6-aminohexanoic acid, 11-aminoundecanoic acid, and 12-aminododecanoic acid.

Product (C) can be a copolymer of alpha-olefin and of an unsaturated carboxylic acid and, advantageously, a copolymer of ethylene and of an unsaturated carboxylic acid. One can mention, in particular, the completely hydrolyzed copolymers of product (B).

According to an advantageous version of the invention, product (C) is a copolymer of ethylene and of (meth)acrylic acid or a copolymer of ethylene, of an alkyl(meth)acrylate and of (meth)acrylic acid. The quantity of (meth)acrylic acid can represent up to 10% by weight and, preferably, from 0.5 to 5% by weight of copolymer (C). The quantity of alkyl(meth)acrylate is generally between 5 and 40% by weight of copolymer (C).

Preferably, product (C) is a copolymer of ethylene, of butyl acrylate and of acrylic acid. One can in particular use the product marketed by the company BASF under the name LUCALENE® 3110.

According to a particular embodiment of the invention, the weight contents of product (A), of product (B), of product (C), denoted [A], [B] and [C], respectively, can be such that the ratio [B]/([A]+[C]) is between 1.5 and 8, the weight contents of products (A) and (B) being such that [C]≦[A].

Advantageously, the ratio [B]/([A]+[C]) can be between 2 and 7.

The dispersed phase of cross-linked polyolefin can naturally originate from the reaction of one or more products (A) with one or more products (B) and, if applicable, with one or more products (C).

One can use catalysts that make it possible to accelerate the reaction between the reactive functions of the products (A) and (B). In particular, one can refer to the teaching of the document WO 2011/015790 insofar as examples of catalysts are concerned; the latter can be used in a weight content between 0.1 and 3% and, advantageously, between 0.5 and 1% of the total weight of the products (A), (B) and, if applicable, (C).

Preferably, when the polyolefin according to the invention is a cross-linked polyolefin, then it is present in the composition in a proportion between 13 and 30% by weight relative to the total weight of the composition.

### The Functionalized Polyolefins:

The composition according to the invention can include at least one functionalized polyolefin (D).

According to the invention, functionalized polyolefin (D) denotes the following polymers.

The functionalized polyolefin (D) can be an alpha-olefin polymer having reactive units: the functionalities. Such reactive units are the carboxylic acid, anhydride or epoxy functions.

As examples, one can mention, as polyolefins, the homopolymers or copolymers of alpha-olefins or of diolefins, such as, for example, ethylene, propylene, 1-butene, 1-octene, butadiene, and more particularly:
the homopolymers and copolymers of ethylene, in particular, LDPE, HDPE, LLDPE (in English: linear low density polyethylene), VLDPE (very low density polyethylene) and metallocene polyethylene,
the homopolymers or copolymers of propylene,
the ethylene/alpha-olefin copolymers such as ethylene/propylene, EPR (English acronym for ethylene-propylene rubber) and EPDM (English acronym for ethylene/propylene/diene monomer, or terpolymer based on ethylene/propylene/styrene),
the styrene/ethylene-butene/styrene (SEBS), styrene/butadiene/styrene (SBS), styrene/isoprene/styrene (SIS), styrene/ethylene-propylene/styrene (SEPS) block copolymers,
the copolymers of ethylene with at least one product chosen from the salts or the esters of unsaturated carboxylic acids, such as alkyl(meth)acrylate (for example, methyl acrylate), or the saturated carboxylic acid vinyl esters such as vinyl acetate (EVA), the proportion of comonomer possibly reaching 40% by weight.

These above-described polyolefins can be grafted, copolymerized or terpolymerized with reactive units (the functionalities) such as the carboxylic acid, anhydride or epoxy functions.

More particularly, these polyolefins are grafted or co- or ter-polymerized with unsaturated epoxies such as glycidyl(meth)acrylate, or with carboxylic acids or the corresponding salts or esters such as (meth)acrylic acid (the latter can be completely or partially neutralized by metals such as Zn, etc.) or with carboxylic acid anhydrides such as maleic anhydride.

The functionalized polyolefin (D) can be chosen from the following (co)polymers, grafted with maleic anhydride or glycidyl methacrylate, in which the grafting ratio is, for example, from 0.01 to 5% by weight:
PE (polyethylene), PP (polypropylene), copolymers of ethylene with propylene, butene, hexene, or octene, containing, for example, from 35 to 80% by weight of ethylene;
the ethylene/alpha-olefin copolymers such as ethylene/propylene, EPR (acronym for ethylene-propylene rubber) and ethylene/propylene/diene (EPDM),
the styrene/ethylene-butene/styrene (SEBS), styrene/butadiene/styrene (SBS), styrene/isoprene/styrene (SIS), styrene/ethylene-propylene/styrene (SEPS) block copolymers,
ethylene and vinyl acetate (EVA) copolymers containing up to 40% by weight of vinyl acetate,
ethylene and alkyl(meth)acrylate copolymers containing up to 40% by weight of alkyl(meth)acrylate,
ethylene and vinyl acetate (EVA) and alkyl(meth)acrylate copolymers containing up to 40% by weight of comonomers.

An example of a functionalized polyolefin is a PE/EPR mixture whose ratio by weight can vary within large ranges, for example, between 40/60 and 90/10, said mixture being co-grafted with an anhydride, in particular maleic anhydride, with a grafting ratio of 0.01 to 5% by weight, for example.

The functionalized polyolefin (D) can also be chosen from the predominantly propylene-containing ethylene/propylene copolymers grafted with maleic anhydride and then condensed with monoaminated polyamide (or a polyamide oligomer) (products described in EP-A-0342066).

The functionalized polyolefin (D) can also be a co- or terpolymer of at least the following units:

(1) ethylene,

(2) alkyl(meth)acrylate or saturated carboxylic acid vinyl ester, and

(3) anhydride such as maleic anhydride or (meth)acrylic acid or epoxy such as glycidyl(meth)acrylate.

As examples of functionalized polyolefins of this last type one can mention the following copolymers, where ethylene preferably represents at least 60% by weight and where the termonomer represents, for example, from 0.1 to 12% by weight of the copolymer:
the ethylene/alkyl(meth)acrylate/(meth)acrylic acid or maleic anhydride or glycidyl methacrylate copolymers;
the ethylene/vinyl acetate/maleic anhydride or glycidyl methacrylate copolymers;
the ethylene/vinyl acetate or alkyl(meth)acrylate/(meth)acrylic acid or maleic anhydride or glycidyl methacrylate copolymers.

In the preceding copolymers, the (meth)acrylic acid can be converted to a salt form with Zn or Li.

The term “alkyl(meth)acrylate” in (D) denotes the C₁ to C₈ alkyl methacrylates and acrylates and can be chosen from methyl acrylate, ethyl acrylate, n-butyl acrylate, iso-butyl acrylate, 2-ethylhexyl acrylate, cyclohexyl acrylate, methyl methacrylate and ethyl methacrylate.

Moreover, the above-mentioned polyolefins (D) can also be cross-linked by any appropriate method or agent (diepoxy, diacid, peroxide, etc.); the term functionalized polyolefin also includes the mixtures of the above-mentioned polyolefins with a difunctional reagent such as diacid, dianhydride, diepoxy, etc., capable of reacting with said polyolefins, or the mixtures of at least two functionalized polyolefins capable of reacting with one another.

The above-mentioned copolymers (D) can be copolymerized in a statistical or sequenced manner and they can have a linear or branched structure.

The molecular weight, the MFI index, the density of these polyolefins can also vary within a large range, which the person skilled in the art will be aware of. The MFI index, acronym for melt flow index, is the fluidity index in the molten state. It is measured according to the standard ASTM 1238.

Advantageously, the functionalized polyolefins (D) are chosen from any polymer including alpha-olefinic units and units that bear polar reactive functions such as the epoxy, carboxylic acid or carboxylic acid anhydride functions. As examples of such polymers, one can mention the terpolymers of ethylene, of alkyl acrylate and of maleic anhydride or of glycidyl methacrylate, such as the Lotader® products of the applicant or polyolefins grafted with maleic anhydride, such as Orevac® products of the applicant as well as terpolymers of ethylene, of alkyl acrylate and of (meth)acrylic acid. One can also mention the homopolymers or copolymers of propylene that have been grafted with a carboxylic acid anhydride and then condensed with polyamides or mono-aminated oligomers of polyamide as described in the application EP 0 342 066.

More particularly, the functionalized polyolefins (D) are:
the terpolymers of ethylene, of alkyl acrylate and of maleic anhydride;
the terpolymres of ethylene, of alkyl acrylate and of glycidyl methacrylate;
the polypropylene and polyethylenes grafted with maleic anhydride;
the copolymers of ethylene and of propylene and optionally of monomer diene which have been grafted with maleic anhydride;
the copolymers of ethylene and of octene which have been grafted with maleic anhydride;

and their mixture.

Preferably, when the polyolefin according to the invention is a functionalized polyolefin (D), then it is present in a proportion between 10 and 30% by weight, preferably between 15 and 25% by weight relative to the total weight of the composition.

### The Nonfunctionalized Polyolefins

Advantageously, the composition according to the invention can include, in addition to a cross-linked and/or functionalized polyolefin, at least one nonfunctionalized polyolefin (E).

A nonfunctionalized polyolefin (E) is conventionally a homopolymer or copolymer of alpha-olefins or of diolefins, such as, for example, ethylene, propylene, 1-butene, 1-octene, butadiene. As examples, one can mention:
the homopolymers and copolymers of polyethylene, in particular, LDPE, HDPE, LLDPE (linear low density polyethylene), VLDPE (very low density polyethylene) and the metallocene polyethylene,
the homopolymers or copolymers of propylene,
the ethylene/alpha-olefin copolymers such as ethylene/propylene, EPR (acronym for ethylene-propylene rubber) and ethylene/propylene/diene (EPDM),

the styrene/ethylene-butene/styrene (SEBS), styrene/butadiene/styrene (SBS), styrene/isoprene/styrene (SIS), styrene/ethylene-propylene/styrene (SEPS) block copolymers,
the copolymers of ethylene with at least one comonomer chosen from the salts or the esters of unsaturated carboxylic acids, such as alkyl(meth)acrylate (for example, methyl acrylate), or the saturated carboxylic acid vinyl esters such as vinyl acetate (EVA), the proportion of monomers possibly reaching 40% by weight relative to the total weight of the copolymer,

and their mixture.

The above-mentioned copolymers (E) can be copolymerized in a statistical or sequenced manner and can have a linear or branched structure.

Advantageously, the nonfunctionalized polyolefins (E) are chosen from the homopolymers or copolymers of polypropylene and from any homopolymer of ethylene or copolymer of ethylene and of a higher alpha-olefinic comonomer such as butene, hexene, octene or 4-methyl-1-pentene. One can mention, for example, the PP (PolyPropylene) compounds, the high-density polyethylenes, the medium-density polyethylenes, the linear low-density polyethylenes, the low-density polyethylenes, the very low-density polyethylenes. These polyethylenes are known to the person skilled in the art as being produced by a free radical method, by Ziegler catalysis or, more recently, by so-called metallocene catalysis. Also preferred are the copolymers of ethylene and of vinyl acetate (EVA), such as those marketed under the commercial name EVATANE by the applicant.

When the composition according to the invention includes a nonfunctionalized polyolefin, then the latter is preferably present in a proportion between 5 and 25% by weight, preferably between 10 and 20% by weight relative to the total weight of the composition.

### The Thermal Stabilizer

The composition according to the invention includes from 0.05 to 0.30% by weight relative to the total weight of the composition of at least one copper heat stabilizer. The copper heat stabilizer is a mixture of potassium iodide and of copper iodide (KI/CuI).

Preferably, the mixture of potassium iodide and of copper iodide that can be used according to the present invention is in a ratio from 90/10 to 70/30.

An example of such a stabilizer is Polyadd P201 from the company Ciba.

More extensive details on the copper-based stabilizers can be found in the U.S. Pat. No. 2,705,227.

It is also possible to use the complexed coppers such as Bruggolen H3336, H3337, H3373 from the company Brueggemann.

Preferably, the composition according to the invention includes from 0.10 to 0.25% by weight of copper heat stabilizer.

The composition according to the invention can consist only of these three families of compounds, namely of at least one polyolefin, of at least one copper heat stabilizer as defined above, and of at least one predominant semi-aromatic copolyamide.

However, the composition can also include other compounds besides those that have just been mentioned. The composition according to the invention can, in particular, include moreover at least one additive and/or at least one additional polymer.

### The Additives

The composition according to the invention can also include moreover at least one additive.

This additive can be chosen, in particular, from the adjuvants transformation aid adjuvants (or processing aids), the fillers, the heat stabilizers other than that defined above, such as the phosphite-based organic heat stabilizers, the dyes, the demolding agents, the flame retardants, the surfactants, the optical brighteners, the antioxidants such as those based on phenol or the product marketed under the name Naugard 445® marketed by the company CHEMTURA, the anti-UV agents such as the HALS products and their mixtures. Preferably, the dyes are present in a proportion from 0 to 1.5%, in particular from 0.5 to 1% by weight relative to the total weight of the composition. Preferably, the heat stabilizers are present in a proportion from 0 to 2%, preferably from 0.5 to 1% by weight relative to the total weight of the composition, and the antioxidants are present in a proportion from 0 to 2%, in particular from 0.5 to 1% by weight relative to the total weight of the composition.

Among the transformation aid adjuvants, or processing aids, one can mention the stearates such as the calcium or zinc stearates, the natural waxes, the polymers including tetrafluoroethylene (TFE).

The weight proportion of processing aids is conventionally between 0.01 and 0.3% by weight, advantageously between 0.02 and 0.1% by weight relative to the total weight of the composition.

Among the fillers, one can mention silica, graphite, expanded graphite, carbon black, glass beads, kaolin, magnesia, scoria, talc, nanofillers (carbon nanotubes), pigments, metal oxides (titanium oxide), metals, (aramid, glass, carbon) fibers.

Depending on the nature of the fillers, the quantity of the latter can represent up to 30% by weight of the total weight of the composition.

### The Additional Polymers

A composition according to the invention can, in addition, include one or more additional polymers, and, in particular, at least one third polymer, such a polymer being different from the semi-aromatic copolyamide(s) and from the polyolefin(s) mentioned above.

Advantageously, this additional polymer can, in particular, be chosen from a polyamide other than the one defined above, a polyamide-block-ether, a polyetheramide, a polyesteramide, a phenylene polysulfide (PPS), a polyphenylene oxide (PPO) a fluorinated polymer, and their mixtures.

The additional polymer can also be chosen from starch, which can be modified and/or formulated, cellulose or its derivatives, such as cellulose acetate or cellulose ethers, lactic polyacid, glycolic polyacid and polyhydroxy alkanoates.

Preferably, the additional polymer is chosen from the aliphatic polyamides and the polyamides-block-ethers. Among the aliphatic polyamides one can mention, in particular, the long-chain polyamides such as PA11, PA12, PA6.10, PA6.12, PA6.14, PA10.10, PA10.12 and PA12.12.

The composition can thus contain up to 20% by weight relative to the total weight of the composition of at least one additional polymer.

### Preparation Method

The invention also relates to a method for preparing a composition as defined above. According to this method, the composition can be prepared by any method that makes it possible to obtain a homogeneous mixture, such as extrusion in the molten state, compacting, or roll mixing.

According to a first embodiment, the composition according to the invention can be prepared by mixing, in the molten state, the semi-aromatic copolyamide(s), the copper heat stabilizer(s), and the polyolefin(s) during the compounding of the composition.

If the polyolefin used is a cross-linked polyolefin, the products (A), (B) and optionally (C) as defined above are introduced into the above-mentioned mixture in the molten state.

According to a second embodiment, the copper heat stabilizer(s) is (are) added to the monomers of the copolyamide during its polycondensation. The composition according to the invention can be prepared by mixing, in the molten state, the semi-aromatic copolyamide(s) which already contain the copper heat stabilizer(s), and the polyolefin(s). The other additives or a or additional copper stabilizer can be added during the compounding.

Additives and/or additional polymers, if any, can themselves be added either at the same time as the semi-aromatic copolyamide(s), copper heat stabilizer(s) and polyolefin(s), and if applicable, or during a later step.

Advantageously, the composition can be obtained in the form of granules by compounding, in particular by means of a two-screw extruder, a co-kneader or an internal mixer. These granules of the composition according to the invention, obtained by the above-described preparation method can then be transformed using tools known to the person skilled in the art (such as an injection molding machine or an extruder) in the form of filaments, tubes, films and/or molded objects.

The method for preparing the composition according to the invention can also use a two-screw extruder that feeds, without intermediate granulation, an injection press or an extruder for the production of filaments, tubes, films and/or molded objects.

The invention thus also relates to a material or article obtained from such a composition as defined above by a known transformation method such as injection, extrusion, extrusion blow-molding, co-extrusion or multi-injection.

### Structure

The invention also relates to the use of a composition as described above to constitute a structure.

This structure can be single-layer when it is formed only from the composition according to the invention.

This structure can also be multilayer, when it includes at least two layers and at least one of these different layers consists of the composition according to the invention. According to an advantageous variant, this multilayer structure can be reinforced and include at least one layer formed by a braid or by fibers.

The invention also relates to a part formed entirely or partially from the composition according to the invention. This part can comprise the single-layer or multilayer structure that has just been mentioned. In particular, such a part can be an injection molded part and, more particularly, an extruded, coextruded, or extruded blow-molded part. It can also be in the form of a tube, a hose, a reservoir, fibers, a film, a sheet or a plate.

Finally, the invention relates to the use of such a part for storing or transporting a fluid. In particular, such a fluid can be chosen from a fuel (such as a gasoline, with or without alcohol, a diesel, or bio-diesel), a refrigeration fluid (such as those used in the air conditioning circuits), a coolant (such as an alcohol- and/or water-based solution which can be used in the engine cooling circuit, a brake fluid, an oil, a lubricant, a hydraulic fluid, a liquid based on a urea solution, a chemical product, water or a gas (such as air, alkanes, hydrogen or carbon dioxide) or emissions of gases or vapors (originating, for example, from the motor), wherein this gas may be pressurized or at low pressure.

The part formed entirely or partially from the composition according to the invention can be used, in particular, for producing all or part of elements of surgical equipment, of packaging, or of leisure or sports articles. This part can also be used for the production of all or part of elements of many types of electrical or electronic equipment, such as solar panels, encapsulated solenoids, bearing cages, pumps, multimedia systems, cables and wires. In particular, the cables and wires can be coated with a layer formed from the composition according to the invention thus constituting a thermal protection sheath.

This part including the composition according to the invention can be used advantageously for the production of all or part of industrial equipment elements for the storage, transport or transfer of fluids such as those listed above, in particular hot fluids such as air, oil, lubricants, hydraulic fluids or petroleum and its compounds. Such equipment can be used in the field of industry in general (for example, for pneumatic or hydraulic lines) as well as in the field of the exploitation of undersea oil and gas deposits (off-shore domain).

This part including the composition according to the invention can very advantageously be used for the production of all or part of elements of car or truck equipment. Such elements can be, in particular, tubes, tube connectors, pumps or injection molded parts used under the engine hood.

In particular, these car or truck equipment elements, particularly when they are in the form of tubes and/or connectors, can be used in particular:
in a device for circulating a gas, pressurized or at low pressure, such as an air intake or ventilation device of gas engines, or a brake assist device,
in a device for the circulation of oil or lubricant, such as an oil cooling device, a hydraulic device or a braking device,
in a device for the circulation of an aqueous or nonaqueous liquid, such as an engine cooling device or a selective catalytic reduction device,
in a device for the circulation of a refrigeration fluid, such as an air conditioning circuit,
in a device for the storage, transport or transfer (or circulation) of fluids, in particular of fuels.

Such elements can of course be made antistatic or conductive, by the prior addition of appropriate quantities of conductive fillers (such as carbon black, carbon fibers, carbon nanotubes, . . . ) in the composition according to the invention.

Finally, the invention relates to the use of 0.05 to 0.50% by weight relative to the total weight of the composition of copper heat stabilizer as defined above within a composition including predominantly at least one semi-aromatic copolyamide of A/X.T structure as defined above and 10 to 36% of polyolefin as defined above for the manufacture of parts that resist aging, particularly in aggressive hot liquids, in particular the coolants.

Other purposes and advantages of the present invention will become apparent upon reading the following examples which are given for information and on a purely non-limiting basis.

### Examples

### Formulation of the Compositions

The compositions tested were prepared from the following products:

11/10.Ta: semi-aromatic copolyamide, having a molar ratio 11/10.T equal to 0.7, obtained by polycondensation of 11-aminocarboxylic acid, 1,10-decanediamine and terephthalic acid, having a glass transition temperature Tg of 88° C., a melting temperature Tf of 260° C., an intrinsic viscosity of 1.22 (measured according to the standard ISO 307), a melting enthalpy of 47 J/g measured by DSC and an amine chain end content of 0.035 meq/g.

11/10.Tb: semi-aromatic copolyamide, having a molar ratio 11/10.T equal to 0.5, obtained by polycondensation of 11-aminocarboxylic acid, 1,10-decanediamine and terephthalic acid, having a glass transition temperature Tg of 88° C., a melting temperature Tf of 270° C., and an intrinsic viscosity of 1.22 (measured according to the standard ISO 307), and a melting enthalpy of 47 J/g, and an amine chain end content of 0.050 meq/g.

The amine chain end content is measured by NMR (Nuclear Magnetic Resonance). The sample is placed at ambient temperature in dichloromethane-d2 with addition of trifluoroacetic anhydride for 16 hours in order to solubilize the polymer. The concentration is on the order of 20 mg/mL.

A proton NMR spectrum is produced at a frequency of 400 MHz on an Avance Bruker 400 (pulse 30°, acquisition time+repetition time=10 seconds) at ambient temperature (stabilized at 27° C.). The chain end contents are calculated directly from the corresponding lines read on the spectrum.

Lotader AX8900: copolymer of ethylene, of methyl acrylate and of glycidyl methacrylate (Et/MA/GMA—68/24/8 by weight), corresponds to product (A)

Lotader 4700: copolymer of ethylene, of ethyl acrylate and of maleic anhydride (Et/EA/MAH—69/30/1 by weight), corresponds to product (B)

Lucalene 3110: copolymer of ethylene, of butyl acrylate and of acrylic acid (Et/BA/AA—88/8/4 by weight), corresponds to product (C)

Iodine 201: heat stabilizer containing by weight 80% KI, 10% CuI, and 10% calcium stearate.

Organic heat stabilizers such as Irgafos 12, antioxidants and dyes are added to some of the compositions tested.

Compositions 1 to 6 were all prepared on a two-screw extruder, in accordance with the formulations detailed in Table 1 below.

Compositions 1 to 4 are compositions according to the invention, whereas compositions 5 and 6 are comparative compositions.

### Production of Dumb-Bell Specimens

Compositions 1 to 6 were injected in the form of ISOR 527 1BA dumb-bell specimens in accordance with the standard ISO 179.

The mechanical tensile properties, that is to say the percentage of elongation at rupture of a sample aged chemically at 130° C. in a 50/50 water/glysantin mixture (glysantin is ethylene glycol), are evaluated.

The samples were evaluated after a residence time in the autoclave of 0 h, 50 h, 350 h, 500 h, 660 h, 1220 h, 1660 h and 1850 h.

Based on these results, the half-life, that is the time after which the percentage of elongation at rupture has decreased by half, is calculated.

The results are described in Table 1 below:

TABLE 1

| Compositions | 1 inv | 2 inv | 3 inv | 4 inv | 5 comp | 6 comp |
|---|---|---|---|---|---|---|
| 11/10.T a | — | — | 69.75 | 69.75 | 69.75 | 68.5 |
| 11/10.T b | 68.35 | 69.75 | — | — | — | — |
| (B) Lotader 4700 | 24 | 24 | 24 | 15 | 15 | 15 |
| (A) Lotader AX8900 | 4 | 4 | 4 | 7.5 | 7.5 | 7.5 |
| (C) Lucalene 3110 | 2 | 2 | 2 | 7.5 | 7.5 | 7.5 |
| Iodine 201 | 0.25 | 0.25 | 0.25 | 0.25 | 0.7 | — |
| Dye | 0.9 | — | — | — | — | — |
| Antioxidant | 0.5 | — | — | — | — | 0.75 |
| Stabilizer | — | — | — | — | — | 0.75 |
| KI/CuI proportion | 0.225 | 0.225 | 0.225 | 0.225 | 0.63 | — |
| (% by weight) | | | | | | |
| MFI (g/10 min) | 0.9 | 2.8 | 2.3 | 1.4 | 4.1 | 1.8 |

ISOR527 1 BA dumb-bell specimens

| | | | | | | |
|---|---|---|---|---|---|---|
| Elongation at rupture (%) | 95 | 110 | 145 | 116 | 105 | 150 |
| ½ life time (hours) | 1850 | 1600 | 1050 | 1200 | 400 | 250 |

### CONCLUSION

The results presented in Table 1 show first that the dumb-bell specimens produced from the composition according to the invention lead to unexpected half-life times.

A comparison of the results obtained with compositions 3 and 4 according to the invention and composition 6 using an organic heat stabilizer reveals a more than 4-fold improvement in terms of the half-life.

A comparison of the results obtained with the compositions 3 and 4 according to the invention and composition 5 using a copper heat stabilizer reveals a 2-fold improvement in terms of the half-life.

The result obtained with compositions 1 and 2 according to the invention was confirmed by extruding tubes having a diameter of 8 mm and a thickness of 1 mm (8×1 mm). The water/glysantin mixture (50/50) at 130° C. passes through the interior of the tube, while the temperature of the air outside is 130° C. After 1500 hours, the tube does not break under DIN impact at 23° C.

1. A composition comprising:
from 10 to 36% by weight of at least one polyolefin,
from 0.05 to 0.30% by weight of at least one copper heat stabilizer, the copper heat stabilizer being a mixture of potassium iodide and copper iodide, and
at least one predominant semi-aromatic copolyamide comprising at least two different units corresponding to the following general formula:
A/X.T
in which:
A is selected from
at least one unit obtained from an amino acid,
at least one unit obtained from a lactam, and
at least one unit corresponding to the formula (Ca diamine).(Cb diacid), with a representing the number of carbon atoms of the diamine between 6 and 18, and b representing the number of carbon atoms of the diacid between 6 and 32, and their mixtures,
X.T denotes a unit obtained from the polycondensation of a Cx diamine denoted X and of terephthalic acid denoted T, with x representing the number of carbon atoms of the Cx diamine, x being between 9 and 36,
the weight percentages being given relative to the total weight of the composition.

2. A composition according to claim 1, wherein the semi-aromatic copolyamide of general formula A/X.T comprises at least one chosen unit A corresponding to the formula (Ca diamine).(Cb diacid), with a representing the number of carbon atoms of the diamine between 7 and 18.

3. A composition according to claim 1, wherein the semi-aromatic copolyamide is selected from the group consisting of PA11/10.T, PA12/10.T, PA6.10/10.T, PA6.12/10.T, PA10.10/10.T, PA10.12/10.T, PA12.12/10.T, PA11/10.T/12, PA11/10.T/6, PA12/10.T/6, PA11/10.T/10.I, PA12/10.T/10.I, PA10.10/10.T/10.I, PA10.6/10.T/10.I and PA10.14/10.T/10.I.

4. A composition according to claim 2, wherein the semi-aromatic copolyamide is selected from the group consisting of PA11/10.T, PA12/10.T, PA10.10/10.T, PA10.12/10.T, PA12.12/10.T, PA11/10.T/12, PA11/10.T/6, PA12/10.T/6, PA11/10.T/10.I, PA12/10.T/10.I, PA10.10/10.T/10.I, PA10.6/10.T/10.I and PA10.14/10.T/10.I.

5. A composition according to claim 3, wherein the semi-aromatic copolyamide is a copolyamide of structure 11/10.T.

6. A composition according to claim 5, wherein the semi-aromatic copolyamide has a molar ratio of unit 11/10.T between 0.5/1.1 and 1/1.1.

7. A composition according to claim 1, wherein the semi-aromatic copolyamide has an amine chain end content between 0.020 and 0.058 meq/g.

8. A composition according to claim 1, wherein the polyolefin is cross-linked polyolefin, the cross-linked polyolefin being obtained from:
at least one product (A) including an unsaturated epoxy, and
at least one product (B) including an unsaturated carboxylic acid anhydride.

9. A composition according to claim 8, wherein the cross-linked polyolefin is obtained from the products (A), (B) and from at least one product (C) including an unsaturated carboxylic acid and an alpha-omega-aminocarboxylic acid.

10. A composition according to claim 1, wherein the polyolefin is a functionalized polyolefin (D) selected from the group consisting of:
terpolymers of ethylene, alkyl acrylate and maleic anhydride;
terpolymers of ethylene, alkyl acrylate and glycidyl methacrylate;
polypropylenes and polyethylenes grafted with maleic anhydride;
copolymers of ethylene and propylene and optionally monomer diene, which have been grafted with maleic anhydride;
copolymers of ethylene and of octene, which have been grafted with maleic anhydride;
and mixtures thereof.

11. A composition according to claim 1, wherein the composition includes a nonfunctionalized polyolefin selected from the group consisting of homopolymers and copolymers of polypropylene, homopolymers of ethylene, copolymers of ethylene and higher alpha-olefinic comonomer, and copolymers of ethylene and of vinyl acetate.

12. A composition according to claim 1, wherein the composition additionally comprises at least one additive selected from the group consisting of transformation aid adjuvants, fillers, the stabilizers other than the copper heat stabilizer of claim 1, dyes, demolding agents, flame retardants, surfactants, optical brighteners, antioxidants, and anti-UV compounds and mixtures.

13. A composition according to claim 1, wherein the composition includes at least one additional polymer chosen from the group consisting of a polyamide other than that claimed in claim 1, a polyamide-block-ether, a polyether amide, a polyester amide, a phenylene polysulfide, a polyphenylene oxide, and a fluorinated polymer.

14. A method for preparing the composition claim 1, comprising mixing, in a molten state, the semi-aromatic copolyamide(s), the polyolefin(s), and the copper heat stabilizer(s), during the compounding.

15. A method for preparing the composition claim 1, comprising adding the copper heat stabilizer(s) to the monomers of the copolyamide during its polycondensation, and then preparing the composition by mixing, in the molten state, the semi-aromatic copolyamide(s), already containing the copper heat stabilizer(s), and the polyolefin(s).

16. A single-layer structure or at least one layer of a multilayer structure comprising a composition in accordance with claim 1.

17. A part formed entirely or in part from the composition of claim 1.

18. A method for storing or transporting a fluid, said fluid being chosen from a fuel, a refrigeration fluid, a coolant, a brake fluid, an oil, a lubricant, a hydraulic fluid, a liquid based on a urea solution, a gas or emissions of gases or vapors, a chemical product and water, wherein the method comprises using a part in accordance with claim 17.

19. A method according to claim 18, wherein the part is used in an air intake or ventilation device of gas engines, in a brake assist device, in an oil cooling device, in a hydraulic device, in a braking device, in an engine cooling device, in a selective catalytic reduction device, in an air conditioning circuit or in a device for storing, transporting or transferring fuels.

20. A method for producing parts that resist aging, wherein the method comprises using to produce the parts a composition comprised of 0.05 to 0.50% by weight relative to the total weight of the composition of a copper heat stabilizer, the copper heat stabilizer being a mixture of potassium iodide and copper iodide and the composition including a polyolefin and predominantly at least one semi-aromatic copolyamide comprising at least two different units corresponding to the following general formula:
A/X.T
in which:
A is selected from
at least one unit obtained from an amino acid,
at least one unit obtained from a lactam, and
at least one unit corresponding to the formula (Ca diamine).(Cb diacid), with a representing the number of carbon atoms of the diamine between 6 and 18, and b representing the number of carbon atoms of the diacid between 6 and 32, and their mixtures,
X.T denotes a unit obtained from the polycondensation of a Cx diamine denoted X and of terephthalic acid denoted T, with x representing the number of carbon atoms of the Cx diamine, x being between 9 and 36,
the weight percentages being given relative to the total weight of the composition.
